(19) United States
(12) Patent Application Publication
(10) Pub. No.: US 2024/0297348 A1
(43) Pub. Date: Sep. 5, 2024

(54) SOLID BATTERY AND METHOD FOR MANUFACTURING SOLID BATTERY

(71) Applicant: HONDA MOTOR CO., LTD., Tokyo (JP)

(72) Inventor: Makiko TAKAHASHI, Saitama (JP)

(21) Appl. No.: 18/585,076

(22) Filed: Feb. 23, 2024

(30) Foreign Application Priority Data
Mar. 3, 2023 (CN) 202310199068.6

(51) Int. Cl. H01M 10/0583; H01M 4/02; H01M 4/38; H01M 10/052

(52) U.S. Cl. CPC H01M 10/0583; H01M 4/382; H01M 10/052; H01M 2004/027

(57) ABSTRACT

Provided is a solid battery comprising an electrode laminate including a porous substrate having a meandering shape, wherein the porous substrate includes adjacent flat portions that are connected by folded portions that are interposed therebetween, the flat portions each include a solid electrolyte layer that is filled with a solid electrolyte, and in the electrode laminate, each of the flat portions has a positive electrode disposed on one surface thereof and a negative electrode disposed on the other surface thereof, the positive electrode including a positive electrode current collector sandwiched between positive electrode mixture layers, the negative electrode including a negative electrode current collector sandwiched between negative electrode mixture layers.

This application is based on and claims the benefit of priority from Chinese Patent Application No. CN202310199068.6, filed on 3 Mar. 2023, the content of which is incorporated herein by reference.

### BACKGROUND OF THE INVENTION

### Field of the Invention

The present invention relates to a solid battery and a method for manufacturing a solid battery.

### Related Art

In recent years, research and development of secondary batteries that contribute to making energy more efficient is being conducted, in order to ensure that many people have access to energy that is reasonably priced, reliable, sustainable, and advanced.

Patent Document 1 describes a secondary battery including a negative electrode layer sheet that is obtained by laminating and forming a negative electrode active material layer on each negative electrode current collector of a negative electrode current collector sheet in which negative electrode current collectors adjacent to each other in the stacking direction are partially connected by a bent connection portion, a positive electrode layer sheet that is obtained by laminating and forming a positive electrode active material layer on each positive electrode current collector of a positive electrode current collector sheet in which positive electrode current collectors adjacent to each other in the stacking direction are partially connected at the bent connection portion, and an electrolyte body that is interposed between the negative electrode active material layer and the positive electrode active material layer. Here, the secondary battery includes a battery laminate that is constituted by the negative electrode layer sheet and the positive electrode layer sheet being folded in the bent connection portion and arranged in a substantially meandering shape, and laminated and integrated in the order of a negative electrode current collector layer, a negative electrode active material layer, an electrolyte layer, a positive electrode active material layer, a positive electrode current collector layer, a positive electrode active material layer, an electrolyte layer, a negative electrode active material layer, a negative electrode current collector layer, and so forth.
Patent Document 1: Japanese Unexamined Patent Application, Publication No. 2020-126769

### SUMMARY OF THE INVENTION

However, in the secondary battery described in Japanese Unexamined Patent Application, Publication No. 2020-126769, there is not provided an isolation wall that isolates the end portions of the positive electrode active material layer and the negative electrode active material layer that are arranged with the electrolyte layer interposed therebetween, and there is thus a possibility that a short circuit may occur.

An object of the present invention is to provide a solid battery that is capable of inhibiting the occurrence of a short circuit.

(1) A solid battery including an electrode laminate including a porous substrate having a meandering shape, wherein the porous substrate includes adjacent flat portions that are connected by folded portions that are interposed therebetween, the flat portions each include a solid electrolyte layer that is filled with a solid electrolyte, and in the electrode laminate, each of the flat portions has a positive electrode disposed on one surface thereof and a negative electrode disposed on the other surface thereof, the positive electrode including a positive electrode current collector sandwiched between positive electrode mixture layers, the negative electrode including a negative electrode current collector sandwiched between negative electrode mixture layers.

(2) The solid battery according to (1), wherein each of the negative electrode mixture layers includes a lithium metal layer.

(3) A method for manufacturing the solid battery according to (1) or (2), the method including: a step of forming the solid electrolyte layer by applying the solid electrolyte to regions that correspond to the flat portions of the porous substrate that is in a sheet shape in which the folded portions are not formed; a step of disposing a first electrode on a first region that corresponds to the flat portion of the porous substrate on which the solid electrolyte layer has been formed; a step of forming one of the folded portions by folding a second region that does not have the solid electrolyte applied thereto and is adjacent to the first region of the porous substrate that has the first electrode disposed thereon; a step of disposing a second electrode on a third region that corresponds to the flat portion and is adjacent to the second region of the porous substrate that has the one of the folded portions formed therein; and a step of forming another of the folded portions by folding a fourth region that does not have the solid electrolyte applied thereto and is adjacent to the third region of the porous substrate that has the second electrode disposed thereon, wherein the first electrode is one of the positive electrode or the negative electrode, and the second electrode is the other of the positive electrode or the negative electrode.

According to the present invention, a solid battery that is capable of inhibiting the occurrence of a short circuit can be provided.

### BRIEF DESCRIPTION OF THE DRAWINGS

FIG. 1 is a cross-sectional view that illustrates an example of a solid battery according to the present embodiment;

FIG. 2 is a schematic diagram that illustrates a method for manufacturing the solid battery of FIG. 1; and

FIG. 3A, 3B, 3C is a schematic diagram that illustrates a method for manufacturing a positive electrode of the solid battery of FIG. 1.

### DETAILED DESCRIPTION OF THE INVENTION

An embodiment of the present invention is described below with reference to the drawings.

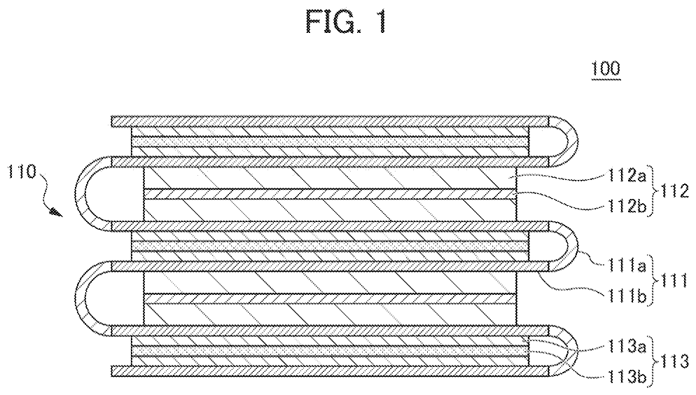

FIG. 1 illustrates an example of a solid battery according to the present invention.

A solid battery 100 includes an electrode laminate 110 including a porous substrate 111 that is folded in a meandering shape. The porous substrate 111 has adjacent flat portions 111b that are connected by folded portions 111a. The flat portions 111b each include a solid electrolyte layer that is filled with a solid electrolyte. In addition, in the electrode laminate 110, each of the flat portions 111b has a positive electrode 112 disposed on one surface thereof and a negative electrode 113 disposed on the other surface thereof. The positive electrode 112 includes a positive electrode current collector 112b sandwiched between positive electrode mixture layers 112a, and the negative electrode 113 includes a negative electrode current collector 113b sandwiched between negative electrode mixture layers 113a. In the solid battery 100, the end portions of the positive electrode mixture layers 112a and the negative electrode mixture layers 113a that are arranged with the flat portions 111b interposed therebetween are isolated by the folded portions 111a, and therefore, the occurrence of a short circuit is inhibited. Particularly, when the negative electrode mixture layer 113a is a lithium metal layer, the occurrence of short circuit due to leakage of lithium is inhibited.

For example, when the solid battery 100 is a lithium metal secondary battery, the electrode laminate 110 may have formed between the flat portions 111b and the negative electrode mixture layers 113a an intermediate layer that has the function of depositing lithium metal in a uniform manner. The lithium metal secondary battery may be an anode-free battery in which there is no negative electrode mixture layer 113a at the time of an initial charge. In this case, a lithium metal layer may be formed as the negative electrode mixture layer 113a after the initial charge and discharge.

The material that constitutes the intermediate layer is not particularly limited, and may include, for example, carbon that carries a metal that is capable of forming an alloy with lithium. The metal that is capable of forming an alloy with lithium is not particularly limited, and may include, for example, silver.

In addition, the number of positive electrodes 112 and negative electrodes 113 that constitute the electrode laminate 110 is not particularly limited. On the surfaces on the sides of the flat portions 111b at the top and the bottom of the drawing where no negative electrode 113 is disposed, there may be disposed a positive electrode in which a positive electrode mixture layer is formed on a positive electrode current collector.

The porous substrate 111 is not particularly limited, so long as the folded portions 111a can be formed and the solid electrolyte can be applied on the flat portions 111b, and may include, for example, a non-woven fabric.

Next, a method for manufacturing the solid battery 100 is described.

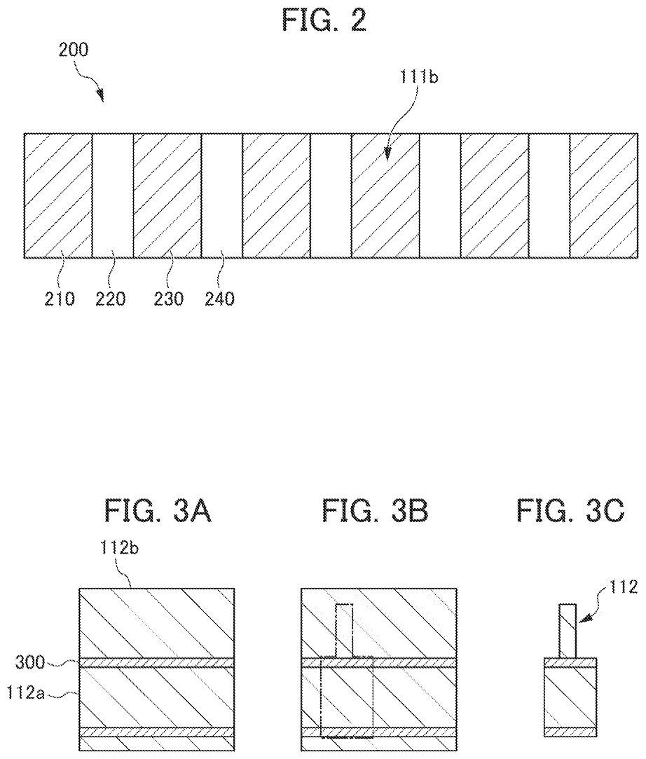

First, the solid electrolyte is applied to regions of a sheet-shaped porous substrate 200 that correspond to the flat portions 111b to form the solid electrolyte layer (see FIG. 2), after which the substrate is roll pressed.

The method for applying the solid electrolyte is not particularly limited, and may include, for example, a method of intermittent coating of a slurry that includes the solid electrolyte. The solvent used in the slurry is not particularly limited, and may include, for example, butyl butyrate.

Next, the negative electrode 113 is disposed on a first region 210 that corresponds to the flat portion 111b of the porous substrate 200 that has the solid electrolyte layer formed thereon, and a second region 220, which does not have the solid electrolyte applied thereto and is adjacent to the first region 210 of the porous substrate 200 that has the negative electrode 113 disposed thereon, is folded in order to form a folded portion 111a. Next, the positive electrode 112 is disposed on a third region 230 that corresponds to the flat portion 111b and is adjacent to the second region 220 of the porous substrate 200 that has the folded portion 111a formed therein. Next, a fourth region 240, which does not have the solid electrolyte applied thereto and is adjacent to the third region 230 of the porous substrate 200 that has the positive electrode 112 disposed thereon, is folded in order to form a folded portion 111a. After repeating the above steps, roll pressing is performed in order to manufacture the solid battery 100. In the solid battery 100, the end portions of the positive electrode mixture layers 112a and the negative electrode mixture layers 113a that are arranged with the flat portions 111b interposed therebetween are isolated by the folded portions 111a, and therefore, the positive electrode mixture layers 112a and the negative electrode mixture layers 113a are allowed to expand at the time of roll pressing, which results in an improved yield rate of the solid battery 100. In addition, the positive electrodes 112 and the negative electrodes 113 that constitute the electrode laminate 110 can be roll pressed in bulk, which shortens the manufacturing process.

It should be noted that roll pressing may be performed every time a predetermined number of positive electrodes 112 and negative electrodes 113 are laminated.

Next, a method for manufacturing the positive electrode 112 is described.

First, the positive electrode mixture layer 112a and an insulating layer 300 are formed by coating onto a predetermined region of the positive electrode current collector 112b (see FIG. 3A). Next, after roll pressing, by punching in a predetermined shape (see FIG. 3B), the positive electrode 112 is obtained (see FIG. 3C). In the solid battery 100, the end portions of the positive electrode mixture layers 112a and the negative electrode mixture layers 113a that are arranged with the flat portions 111b interposed therebetween are isolated by the folded portions 111a (see FIG. 1), and therefore, the positive electrode 112 does not have an insulating layer formed on both sides in the left-right direction in the drawings. This allows for continuous coating of the positive electrode mixture layer 112a (see FIG. 3A), which results in a shortening of the manufacturing process. In addition, the positive electrode mixture layer 112a can be pressed in a uniform manner, which results in improved performance of the solid battery 100. Further, because the effective area of the positive electrode 112 is increased, the energy density of the solid battery 100 is improved.

The method for manufacturing the negative electrode 113 is the same as the method for manufacturing the positive electrode 112.

The material that constitutes the insulating layer 300 is not particularly limited, so long as the material has electron-insulating properties, and may include, for example, resins such as polyvinylidene fluoride (PVDF), rubbers such as styrene-butadiene rubber (SBR), and the like.

The insulating layer 300 may have ionic conductivity.

The solid battery 100 is not particularly limited, and may include, for example, all-solid batteries such as an all-solid lithium-ion battery and an all-solid lithium metal battery.

Described below is a case where the solid battery according to the present embodiment is an all-solid lithium-ion battery.

The positive electrode current collector is not particularly limited, and may include, for example, an aluminum foil and the like.

The positive electrode mixture layer includes a positive electrode active material, and may further include a solid electrolyte, a conduction promoting agent, a binder, and so forth.

The positive electrode active material is not particularly limited, so long as it is capable of storing and releasing lithium ions, and may include, for example, LiCoO₂, Li(Ni_{5/10}Co_{2/10}Mn_{3/10}) O₂, Li(Ni_{6/10}CO_{2/10}Mn_{2/10}) O₂, Li(Ni_{8/10}Co_{1/10}Mn_{1/10}) O₂, Li(Ni_{0.8}Co_{0.15}Al_{0.05}) O₂, Li(Ni_{1/6}CO_{4/6}Mn_{1/6}) O₂, Li(Ni_{1/3}CO_{1/3}Mn_{1/3}) O₂, LiCoO₄, LiMn₂O₄, LiMn_{1.5}Ni_{0.5}O₄, LiNiO₂, LiFePO₄, lithium sulfide, sulfur, and the like.

The solid electrolyte that constitutes the solid electrolyte layers is not particularly limited, so long as the material thereof is capable of conducting lithium ions, and may include, for example, an oxide-based electrolyte, a sulfide-based electrolyte, and the like.

The negative electrode mixture layer includes a negative electrode active material, and may further include a solid electrolyte, a conduction promoting agent, a binder, and so forth.

The negative electrode active material is not particularly limited, so long as it is capable of storing and releasing lithium ions, and may include, for example, metallic lithium, a lithium alloy, a metal oxide, a metal sulfide, a metal nitride, Si, SiO, a carbon material, and the like. The carbon material may include, for example, artificial graphite, natural graphite, hard carbon, soft carbon, and the like.

The negative electrode current collector is not particularly limited, and may include, for example, a silver foil and the like.

An embodiment of the present invention is described above, but the present invention is not limited to the above embodiment, and the above embodiment may be modified as appropriate within the scope and spirit of the present invention.

### EXPLANATION OF REFERENCE NUMERALS

100 Solid battery
110 Electrode laminate
111 Porous substrate
111a Folded portion
111b Flat portion
112 Positive electrode
112a Positive electrode mixture layer
112b Positive electrode current collector
113 Negative electrode
113a Negative electrode mixture layer
113b Negative electrode current collector
200 Porous substrate
210 First region
220 Second region
230 Third region
240 Fourth region
300 Insulating layer

What is claimed is:

1. A solid battery comprising an electrode laminate including a porous substrate having a meandering shape, wherein
the porous substrate includes adjacent flat portions that are connected by folded portions that are interposed therebetween,
the flat portions each include a solid electrolyte layer that is filled with a solid electrolyte, and
in the electrode laminate, each of the flat portions has a positive electrode disposed on one surface thereof and a negative electrode disposed on the other surface thereof, the positive electrode including a positive electrode current collector sandwiched between positive electrode mixture layers, the negative electrode including a negative electrode current collector sandwiched between negative electrode mixture layers.

2. The solid battery according to claim 1, wherein each of the negative electrode mixture layers includes a lithium metal layers.

3. A method for manufacturing the solid battery according to claim 1, the method comprising:
a step of forming the solid electrolyte layer by applying the solid electrolyte to regions that correspond to the flat portions of the porous substrate that is in a sheet shape in which the folded portions are not formed;
a step of disposing a first electrode on a first region that corresponds to the flat portion of the porous substrate on which the solid electrolyte layer has been formed;
a step of forming one of the folded portions by folding a second region that does not have the solid electrolyte applied thereto and is adjacent to the first region of the porous substrate that has the first electrode disposed thereon;
a step of disposing a second electrode on a third region that corresponds to the flat portion and is adjacent to the second region of the porous substrate that has the one of the folded portions formed therein; and
a step of forming another of the folded portions by folding a fourth region that does not have the solid electrolyte applied thereto and is adjacent to the third region of the porous substrate that has the second electrode disposed thereon, wherein
the first electrode is one of the positive electrode or the negative electrode, and
the second electrode is the other of the positive electrode or the negative electrode.
